(19) United States
(12) Patent Application Publication
(10) Pub. No.: US 2012/0114860 A1
(43) Pub. Date: May 10, 2012

(54) METHOD OF INHIBITING FORMATION OF DEPOSITS IN A MANUFACTURING SYSTEM

(76) Inventors: Max Dehtiar, Saginaw, MI (US); Jason Giardina, Freeland, MI (US); Jaime Vanderhovel, Clio, MI (US); Michael Hofmeister, Midland, MI (US); Michael John Molnar, Freeland, MI (US); Robert E. Stratton, Midland, MI (US); Stephen Pawelkowski, Midland, MI (US)

(21) Appl. No.: 13/383,598

(22) PCT Filed: Jul. 14, 2010
(86) PCT No.: PCT/US10/41961

§ 371 Date: Jan. 12, 2012

Related U.S. Application Data
(60) Provisional application No. 61/225,347, filed on Jul. 14, 2009.

(51) Int. Cl. B05D 1/00

(52) U.S. Cl. 427/345; 118/602

(57) ABSTRACT

A method inhibits formation of deposits on a cooling surface of an electrode. The electrode is used in a manufacturing system that deposits a material on a carrier body. The cooling surface comprises copper. The system includes a reactor defining a chamber. The electrode is at least partially disposed within the chamber and supports the carrier body. A circulation system, in fluid communication with the electrode, transports a coolant composition to and from the cooling surface. The coolant composition comprises a coolant and dissolved copper from the cooling surface. A filtration system is in fluid communication with the circulation system. The method heats the electrode. The cooling surface of the electrode is contacted with the coolant composition. The material is deposited on the carrier body, and the coolant composition is filtered with the filtration system to remove at least a portion of the dissolved copper therefrom.

### FIELD OF THE INVENTION

The present invention generally relates to a manufacturing system including an electrode and a method of inhibiting formation of deposits on the electrode. More specifically, the present invention relates to a manufacturing system including an electrode that is used for depositing a material on a carrier body and that is cooled with a coolant composition, and a method of inhibiting formation of deposits on the electrode as a result of contact between the electrode and the coolant composition.

### BACKGROUND OF THE INVENTION

Methods for depositing a material on a carrier body are known in the art. One such method uses a manufacturing system, which includes a reactor defining a chamber. An electrode is disposed within the chamber for supporting the carrier body within the chamber. Typically, the electrode comprises a highly conductive material, such as copper. The manufacturing system also includes a power supply coupled to the electrode for providing an electric current to the electrode such that electric current passes through the electrode and into the carrier body. The passage of the electric current generates heat within the electrode and heats the carrier body to a deposition temperature.

A reactive gas and a precursor comprising the material are introduced into the chamber. Once the carrier body reaches the deposition temperature, the precursor reacts with the reactive gas resulting in the depositing of the material on the carrier body. However, the material will also be deposited onto the electrode if the electrode reaches the deposition temperature. Thus, it is desirable to prevent the electrode from reaching the deposition temperature while still enabling the carrier body to reach the deposition temperature.

There are several known methods for preventing the electrode from reaching the deposition temperature. In one embodiment, the electrode has a cooling surface and a coolant composition is provided for contacting the cooling surface to dissipate heat generated within the electrode. The contact between the coolant composition and the cooling surface of the electrode results in the formation of undesirable deposits on the cooling surface. The deposits decrease the rate of heat transfer between the coolant composition and the electrode.

It has been observed that the formation of the deposits on the electrode may depend on the type of coolant composition used. For example when the coolant composition is tap water, minerals can be suspended in the tap water and are deposited on the cooling surface. An attempted solution to the problems associated with the use of tap water as the coolant composition has been the use of deionized water, which lacks suspended minerals in the coolant composition. However, the use of deionized water yields only a slight delay in the formation of deposits on the electrode.

A fouling of the electrode occurs once the formation of deposits on the cooling surface are so extensive that the coolant composition cannot prevent the electrode from reaching the deposition temperature and the material becomes deposited on the electrode. Once fouling of the electrode occurs, the electrode must be replaced, which adds to production costs. Generally, the electrode has a life determined by the number of the carrier bodies the electrode can process before the electrode must be replaced. Additionally, once fouling and replacement of the electrode occurs, the coolant composition must also be replaced, further adding to the production costs.

It is to be appreciated that in the art of power generation, coolant compositions are also used to dissipate heat. In power generation, minerals in the coolant composition can increase the electrical conductivity of the coolant composition, resulting in damage to power generation equipment and a reduction in efficiency due to the highly sensitive nature of the power generation equipment. Further, the power generation equipment handles high amounts of electricity, which makes containment of the electricity through maintaining electrical conductivity of the coolant composition very important for safety and efficiency purposes. Therefore, in power generation, the control of minerals in the coolant composition is critical for the reduction of the electrical conductivity of the coolant composition and steps have been taken to remove minerals in the coolant composition through numerous mechanisms.

Accordingly, it would be advantageous to further develop a method of inhibiting the formation of deposits on the cooling surface of the electrode.

### SUMMARY OF THE INVENTION AND ADVANTAGES

A method of inhibiting formation of deposits on a cooling surface of an electrode used in a manufacturing system for depositing a material on a carrier body is disclosed. The manufacturing system includes at least one reactor defining a chamber. At least one electrode is at least partially disposed within the chamber for supporting the carrier body within the chamber and the cooling surface of the electrode comprises copper. The manufacturing system also includes a coolant composition comprising a coolant and dissolved copper. A circulation system is coupled to the electrode and contains the coolant composition for transporting the coolant composition to and from the cooling surface of the electrode. The system further includes a filtration system in fluid communication with the circulation system. The method comprises the steps of heating the electrode supporting the carrier body and contacting the cooling surface of the electrode with the coolant composition. The method also includes the steps of depositing the material on the carrier body supported by the electrode and filtering the coolant composition with the filtration system to remove at least a portion of the dissolved copper therefrom.

As a result of contact between the cooling composition and the cooling surface, that comprises copper, copper dissolves into the coolant composition. It has been discovered that the dissolved copper is primarily responsible for the formation of the deposits on the cooling surface. Thus, one advantage of filtering the coolant composition is that it is possible to inhibit the formation of the deposits on the cooling surface for allowing heat within the electrode to be dissipated, thereby delaying the fouling of the electrode. Delaying the fouling of the electrode extends the life and productivity of the electrode. Another advantage of filtering the coolant composition is that the filtering increases a life of the coolant composition. Increasing the life of the electrode and the coolant composition increases productivity of the manufacturing system and decreases production costs.

### BRIEF DESCRIPTION OF THE DRAWINGS

Other advantages of the present invention will be readily appreciated, as the same becomes better understood by reference to the following detailed description, when considered in connection with the accompanying drawings wherein:

FIG. 1 is a schematic representation of a manufacturing system for depositing a material on a carrier body with the manufacturing system having at least one reactor coupled to a filtration system;

FIG. 2 is a partial cross sectional view of the reactor;

FIG. 3 is a cross sectional view of an electrode utilized within the reactor of FIG. 1;

FIG. 4 is a schematic representation of a circulation system containing a coolant composition with the coolant composition in contact with the electrode and the filtration system;

FIG. 5 is a schematic representation of the manufacturing system with the filtration system comprising a reverse osmosis processor; and

FIG. 6 is a schematic representation of the manufacturing system comprising a degasifier in fluid communication with the circulation system.

### DETAILED DESCRIPTION OF THE INVENTION

Referring to the Figures, wherein like numerals indicate like or corresponding parts throughout the several views, a manufacturing system 20 for depositing a material on a carrier body 22 is disclosed. In one exemplary embodiment described additionally below, the material is silicon. However, it is to be appreciated that other materials known in the art can be deposited on the carrier body 22 without deviating from the scope of the subject invention. When the material is silicon, the carrier body 22 is typically a silicon slim rod.

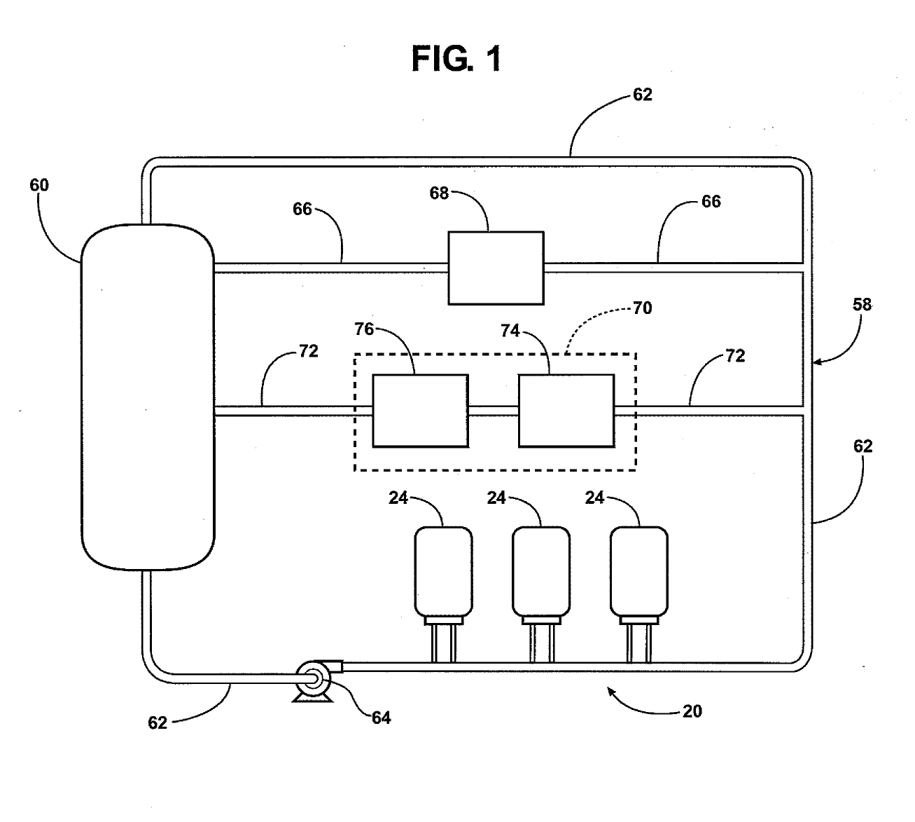

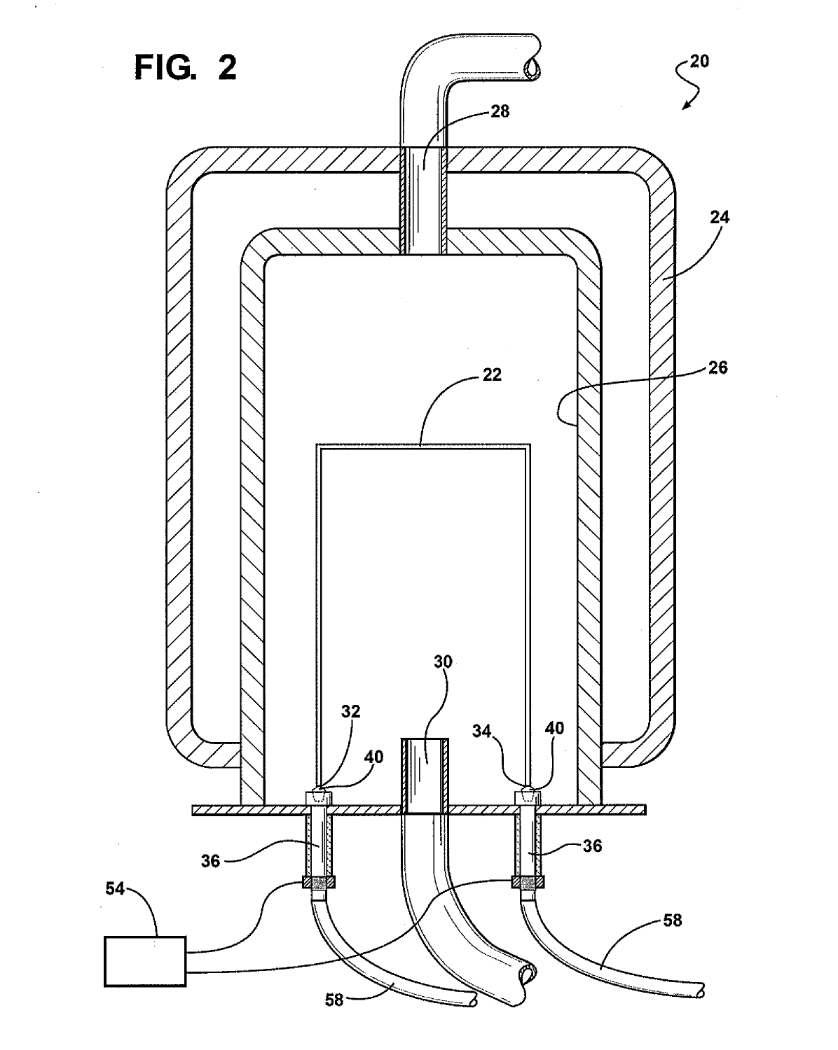

Referring to FIGS. 1 and 2, the manufacturing system 20 includes at least one reactor 24 that defines a chamber 26. The reactor 24 can be of any type suitable for deposition of the material on a carrier body 22, such as a chemical vapor deposition reactor. The reactor 24 also defines an inlet 28 and an outlet 30 for allowing access to the chamber 26.

A precursor, comprising the material, is used to transport the material into the chamber 26. In particular, the material is deposited on the carrier body 22 as a result of a reaction of the precursor and a reactive gas. The material deposited on the carrier body 22 is dependent on the type of precursor used.

As an example, when the precursor comprises a halosilane such as trichlorosilane, the trichlorosilane, which is itself a gas in this application, is reacted with a reactive gas such as hydrogen through thermal cracking and hydrogen reduction to produce silicon. The silicon is deposited on the carrier body 22 and may react with the silicon of the carrier body 22 to form polycrystalline silicon (where, for example, the carrier body 22 is the silicon slim rod as described above). In this embodiment, the material is further defined as silicon. However, it is to be appreciated that the precursor is not limited to a trichlorosilane and can comprise other compounds comprising silicon. For example, the precursor can comprise silicon tetrachloride and/or tribromosilane. Furthermore, it is to be appreciated that materials other than silicon or in addition to silicon can also be deposited on the carrier body 22, in which case other precursors may alternatively be used.

The precursor enters the chamber 26 through the inlet 28 and any unreacted precursor, reactive gas, and by-products of the reaction of the precursor and the reactive gas are exhausted from the chamber 26 through the outlet 30.

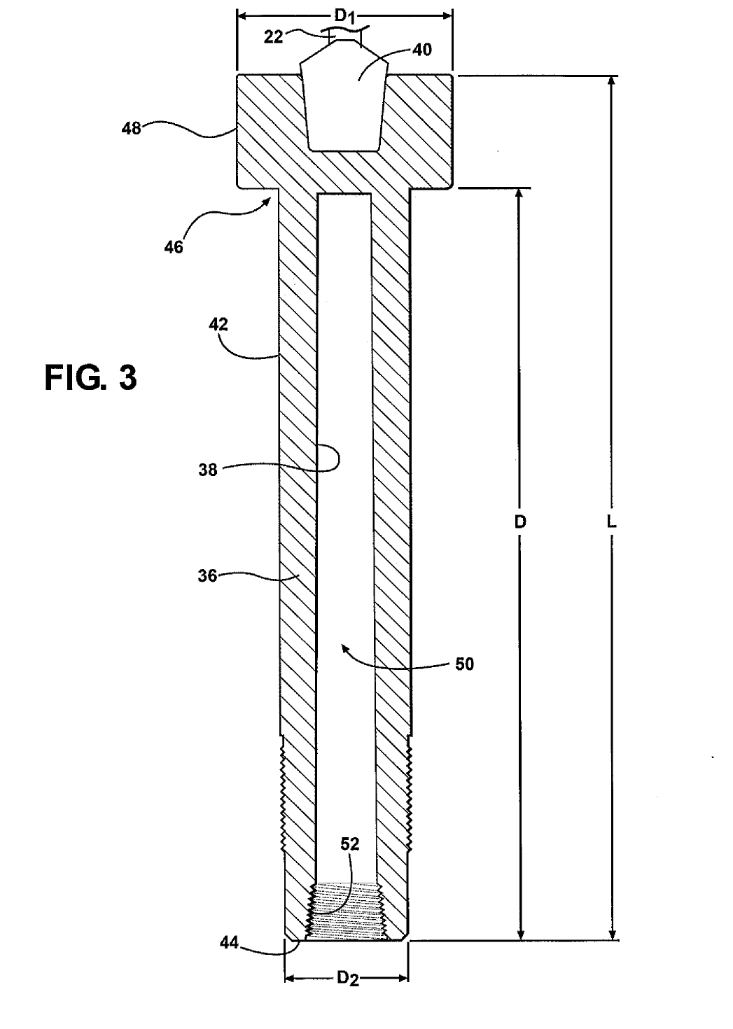

As shown in FIG. 2, the manufacturing system 20 also includes at least one electrode 36 at least partially disposed within the chamber 26 of the reactor 24 for supporting the carrier body 22 within the chamber 26. Said differently, the electrode 36 can be either fully or partially disposed within the chamber 26 of the reactor 24. The electrode 36 supports the carrier body 22 to prevent the carrier body 22 from moving relative to the reactor 24 during the deposition of the material. It is to be appreciated that the electrode 36 can be any type of electrode 36 known in the art for example, a flat head electrode, a two-part electrode, or a cup electrode as shown in FIG. 3.

In one embodiment, the carrier body 22 has a U-shaped configuration with a first end 32 and a second end 34 spaced from each other. When the carrier body 22 is U-shaped, two electrodes 36 are utilized such that each of the electrodes 36 receives one of the ends 32, 34 of the carrier body 22.

Although not required, a socket 40 is typically disposed between the carrier body 22 and the electrode 36 for allowing the carrier body 22 to be easily separated from the electrode 36 after the material has been deposited onto the carrier body 22. When the carrier body 22 is U-shaped, a pair of sockets 40 are used such one socket 40 is disposed on one of the ends 32, 34 of the carrier body 22 and another socket 40 is disposed on the other of the ends, 32, 34. It is to be appreciated by those skilled in the art that the method of connecting the carrier body 22 to the electrode 36 can vary depending on the type of electrode 36 used and the configuration of the carrier body 22 without departing from the scope of the instant invention.

Referring to FIG. 3, the electrode 36 has a shaft 42 that is generally cylindrically shaped having a bottom end 44 and a top end 46. When the electrode 36 is partially disposed within the chamber 26 of the reactor 24 as described above, the top end 46 of the shaft 42 is disposed within the chamber 26. It is to be appreciated that the shaft 42 can be a different shape other than cylindrical, including, but not limited to a square, rectangle, or triangle without deviating from the scope of the instant invention.

In one embodiment, the electrode 36 includes a head 48 disposed at the top end 46 of the shaft 42. The head 48 and the shaft 42 each have a diameter D1, D2, respectively. Typically, the diameter D1 of the head 48 is larger than the diameter D2 of the shaft 42. Due to the diameter D1 of the head 48 relative to the diameter D2 of the shaft 42, the carrier body 22 can be supported in the chamber 26. When present, the head 48 is disposed within the chamber 26 for receiving the carrier body 22.

The electrode 36 comprises an electrically conductive material having a minimum electrical conductivity at room temperature of about 44×10⁶ Siemens/meter (S/m). In one embodiment, the electrode 36 comprises copper and the copper is typically present in an amount of from about 100% by weight based on the weight of the electrode 36. However, the electrode 36 can comprise other suitable materials meeting the minimum electrical conductivity, such as silver or gold.

The electrode 36 has a cooling surface 38 that is atmospherically isolated from the chamber 26 of the reactor 24. Atmospherically isolating the cooling surface 38 from the chamber 26 prevents the introduction of contaminates into the chamber 26 which can affect the depositing of the material onto the carrier body 22. In one embodiment, the cooling surface 38 defines a channel 50 within the electrode 36 and the bottom end 44 of the shaft 42 defines a hole 52 for accessing the channel 50. The channel 50 extends within the electrode 36 a distance D such that the distance D is less than a length L of the electrode 36. Said differently, the channel 50 does not extend completely through the electrode 36. In an alternatively contemplated embodiment, the cooling surface 38 is an exterior of the electrode 36.

The cooling surface 38 comprises copper. Typically, the copper is present in the cooling surface 38 an amount of about 100% by weight. One example of suitable copper for both the electrode 36 and the cooling surface 38 is oxygen-free electrolytic copper grade UNS 10100. The copper of the cooling surface 38 provides the cooling surface 38 with excellent heat transfer properties. When the electrode 36 and the cooling surface 38 each comprise copper, the cooling surface 38 can be integral to the electrode 36. However, the cooling surface 38 and the electrode 36 can comprise different types of copper, in which case the cooling surface 38 is not integral with the electrode. Furthermore, when the electrode 36 does not comprise copper as described above, the cooling surface 38 is not integral to the electrode 36. In such an example where the cooling surface 38 in not integral with the electrode 36, the cooling surface 38 may be disposed adjacent to the electrode 36 by any acceptable methods known, such as electroplating.

Referring back to FIG. 2, the manufacturing system 20 may also include a power supply 54 coupled to the electrode 36 for providing an electric current to the electrode 36. The passage of the electric current through the electrode 36 results in the generation of heat within the electrode 36. Such heating is known to those skilled in the art as Joule heating. Additionally, the electric current passes through the electrode 36 and into the carrier body 22 resulting in the generation of heat within the carrier body 22 through the Joule heating. When silicon is the material deposited on the carrier body 22, and hydrogen is used as the reactive gas, heating the carrier body 22 to the deposition temperature results in the silicon produced from the reaction of the precursor and hydrogen to deposit on and possibly react with the carrier body 22. Generally, the silicon is deposited onto any structure within the chamber 26 of the reactor 24 that reaches the deposition temperature.

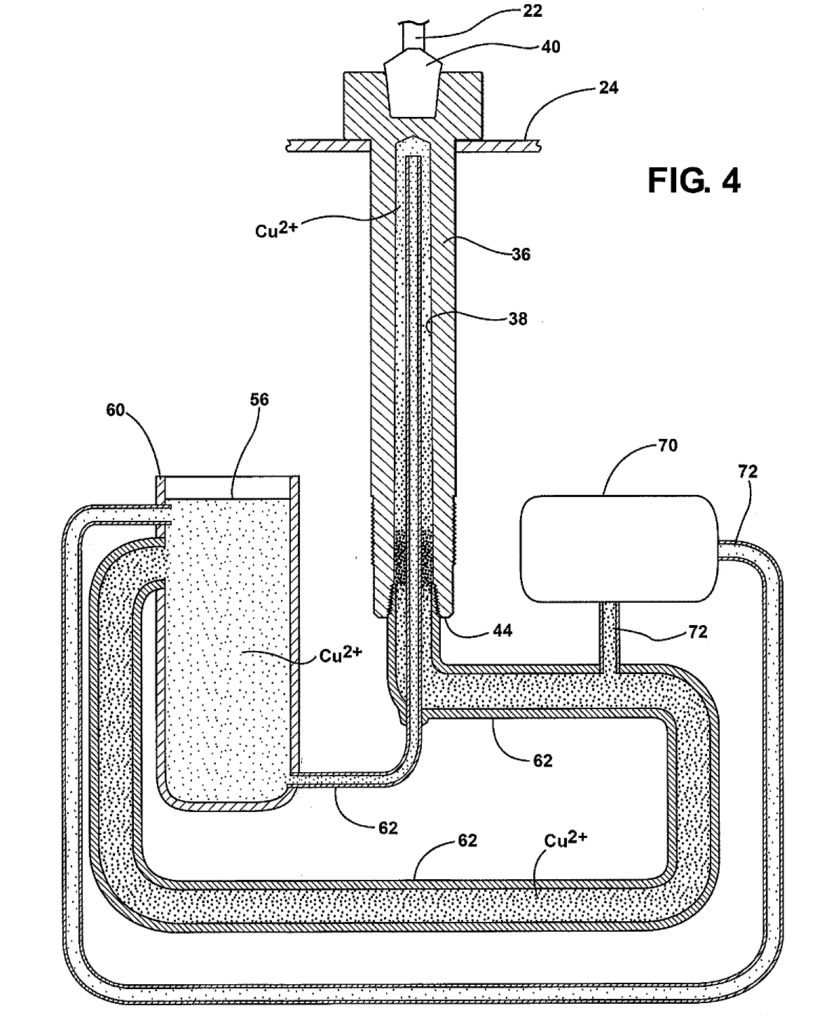

Referring to FIG. 4, a coolant composition 56 is used within the manufacturing system 20 for dissipating heat generated in the manufacturing system 20. For example, the coolant composition 56 contacts the cooling surface 38 of the electrode 36 to dissipate heat generated in the electrode 36. It is to be appreciated that the coolant composition 56 may contact other parts of the manufacturing system 20, including, but not limited to, the power supply 54 and other electrical components such as cables to dissipate heat generated in the power supply 54. When the cooling surface 38 defines the channel 50, the coolant composition is circulated within the channel 50. Alternatively, when the cooling surface 38 is the exterior of the electrode 36, the coolant composition 56 simply contacts the exterior of the electrode 36. Dissipation of the heat within the electrode 36 prevents the electrode 36 from reaching the deposition temperature so material is not deposited on the electrode 36. A circulation system 58 is coupled to the electrode 36 and contains the coolant composition 56 for transporting the coolant composition 56 to and from the cooling surface 38 of the electrode 36. The circulation system 58 transports the coolant composition 56 into contact with the cooling surface 38 of the electrode 36. As alluded to above, it is to be appreciated that the manufacturing system 20 may comprise a plurality of reactors 24 with a plurality of electrodes 36 within each reactor, in which case the circulation system 58 is coupled to each of the electrodes 36.

Referring back to FIG. 1, the circulation system 58 includes at least one main storage tank 60, which is typically open to the atmosphere, for holding the coolant composition 56. The circulation system 58 also includes a main branch 62, which fluidly connects the main storage tank 60 with the electrode 36 for transporting the coolant composition 56 between the main storage tank 60 and the electrode 36 within the reactor 24. The main branch 62 comprises a plurality of structural elements suitable for transporting the coolant composition 56 such as pipes, tubes, conduits and the like. A pump 64 is in fluid communication with the main branch 62 for circulating the coolant composition 56 through the circulation system 58. The pump 64 may be of any type suitable for circulating the coolant composition 56 within the circulation system 58.

The coolant composition 56 is typically present within the circulation system 58 in a total volume and passes through the circulation system 58. It is to be appreciated that the total volume of the coolant composition 56 present may be dependent upon various factors such as a surface area of the cooling surface 38 resulting in the total volume being different for different manufacturing systems 20. Typically, the coolant composition 56 is circulated through the circulation system 58 at a flow rate of less than about 4,300, more typically of from about 2,200 to 4,300 gallons per minute (GPM). A circulation cycle is defined by the passage of an amount of the coolant composition 56 through the pump 64 equal to the total volume of the coolant composition 56 present in the circulation system 58.

The coolant composition 56 comprises a coolant for dissipating heat within the electrode 36 through thermal conduction between the cooling surface 38 and the coolant composition 56. Preferably, the coolant is deionized water due to the absence of minerals in deionized water however; it is to be appreciated that the coolant may be other fluids used for thermal conduction such as antifreeze, or tap water. The coolant composition 56 may also comprise dissolved gasses because the circulation system 58 is typically open to the atmosphere, which allows oxygen and carbon dioxide from the atmosphere to dissolve into the coolant composition 56. Therefore, the coolant composition 56 may comprise dissolved oxygen and dissolved carbon dioxide. However, it is to be appreciated that the circulation system 58 may be isolated from the atmosphere to prevent dissolved gasses from entering the coolant composition 56. When the circulation system 58 is isolated from the atmosphere, air may become trapped within the filtration system 70. For example, air may become trapped when the electrode 36 is replaced or as the coolant composition 56 is added to the circulation system 58. It is to be appreciated that the electrode 36 may be fitted with a purge connection to eliminate air that may become trapped within the circulation system 58.

As a result of the contact between the coolant composition 56 and the cooling surface 38 of the electrode 36, there is a presence of dissolved copper within the coolant composition 56, in the form of cupric (Cu²⁺) ions. As such, after the coolant composition 56 contacts the cooling surface 38, the coolant composition 56 comprises the coolant and the dissolved copper. It is to be appreciated that the coolant composition 56 may contact other parts of the manufacturing system that comprise copper, including, but not limited to, the power supply 54 and other electrical components such as cables, which can also contribute to the presence of dissolved copper within the coolant composition 56. It is believed the dissolved copper is introduced into the coolant composition 56 as a result of a degradation of the cooling surface 38. It is further believed that the dissolved copper or Cu²⁺ ions react with the dissolved oxygen to form copper oxide CuO, which precipitates out of the coolant composition 56 to form a deposit on the cooling surface 38 of the electrode 36.

It is believed that the degradation of the cooling surface 38 is influenced by a pH of the coolant composition 56. The dissolved carbon dioxide in the coolant composition 56 forms bicarbonate (HCO₃⁻) through an equilibrium reaction, which tends to lower the pH of the coolant composition 56. Therefore, the amount of the bicarbonate present in the coolant composition 56 can be determined as a function of the change in the pH of the coolant composition 56 and the total volume of the coolant composition 56 present in the circulation system 58.

It is believed that degradation of the cooling surface 38 occurs as the bicarbonate reacts with the copper of the cooling surface 38, resulting in the degradation of the cooling surface 38, and the presence of dissolved copper in the coolant composition 56. The dissolved copper is suspended in the coolant composition 56 and circulated through the circulation system 58, thereby resulting in the formation of the deposits on the cooling surface 38 of the electrode 36 as described above.

Without being bound by any particular theory, it is believed that controlling the amount of dissolved copper in the coolant composition 56 and the pH of the coolant composition 56 will inhibit the formation of deposits on the cooling surface 38 of the electrode 36. For example, it is believed that that the rate of deposit formation on the cooling surface 38 increases when a solubility limit of copper into the coolant composition 56 is reached and the pH is below 7.0. It is also believed that the rate of deposit formation on the cooling surface 38 increases as the concentration of dissolved copper in the cooling composition increases and the pH is above 7.0. It is also believed that inhibiting the formation of deposits on the electrode 36 can also be accomplished by controlling an amount of dissolved oxygen in the coolant composition 56 by using a deareation system that isolates the coolant composition 56 from the atmosphere thereby preventing the formation of copper oxide. In such a system, the presence of dissolve copper in the absence of dissolved oxygen does not result in the formation of deposits on the electrode 36. However, it is believed that generally it is more effective to control the amount of dissolved copper in the coolant composition 56 rather than using the deareation system.

Inhibiting the formation of the deposits extends a life of the electrode 36 and a life of the coolant composition 56, which decreases production costs because the electrode 36 and coolant composition are not required to be replaced as often. Additionally, the production time to deposit the material on the carrier body 22 is also decreased because replacement of electrodes 36 occurs less frequently, as compared to when the coolant composition 56 has a greater presence of dissolved copper. Furthermore, the reduction in deposit formation on the cooling surface 38 of the electrode 36 also has the added benefit of improving cooling within the chamber 26 of the reactor 24, which benefits the productivity and extends the life of the reactor 24. In particular, reduction in the formation of the deposits on the cooling surface 38 enables the electrode 36 to be cooled more efficiently and thereby draw heat from the chamber 26, which prevents the reactor 24 from operating at unnecessarily high temperatures.

As stated above, the presence of the bicarbonate in the coolant composition 56 lowers the pH of the coolant composition 56. Generally, the lower, or more acidic, the pH is, the faster the degradation of the cooling surface 38, resulting in higher concentrations of dissolved copper present in the coolant composition 56. It is believed that the degradation of the cooling surface 38 can be minimized by maximizing the pH of the coolant composition 56. Typically, the pH of the coolant composition 56 is above 7.0. However, as the pH of the coolant composition 56 becomes basic, there is an increase in an electrical conductivity of the coolant composition 56. High electrical conductivity can result in electrical arcing, which can damage the electrode 36. Generally, high electrical conductivity of the coolant composition 56 is not a large problem but may be monitored to protect the electrode 36. Typically, if the pH of the coolant composition 56 is above 9.5, the electrical conductivity is too high and may result in damage to the electrode 36. In view of the foregoing, the manufacturing system 20 employs a three-layer control strategy to inhibit the formation of the deposits on the electrode 36. Generally, a first layer of the three-layer control strategy includes a filtration system 70 for filtering the coolant composition 56 to remove at least a portion of the dissolve copper in the coolant composition 56. A second layer of the three-layer control strategy includes maintaining a desired pH of the coolant composition 56 to minimize the degradation of the cooling surface 38. A third layer of the three-layered control strategy includes maintaining a desired electrical conductivity of the coolant composition 56 to prevent electrical arching. One advantage of the three-layer control strategy is that it identifies and controls factors that influence deposit formation on the cooling surface 38. Controlling the factors that influence deposit formation maximizes the life of the electrode, which decreases costs and replacement downtime. It is to be appreciated that the three-layer control strategy can be automated or manually performed.

The filtration system 70 is in fluid communication with the circulation system 58 for removing the dissolved copper from the coolant composition 56. As described above, the dissolved copper in the coolant composition 56 results in the formation of the deposits on the cooling surface 38. More specifically, the amount of dissolved copper in the coolant composition 56 at the point of contact between the coolant composition 56 and the cooling surface 38 has the greatest impact on the formation of deposits on the cooling surface 38. Therefore, it is preferred to control the amount of dissolved copper in the coolant composition 56 adjacent to the cooling surface 38 of the electrode 36. Said differently, it is preferred to control the amount of dissolved copper in the coolant composition 56 prior to the coolant composition 56 coming into contact with the cooling surface 38. Typically, an average concentration of the dissolved copper present in the coolant composition 56 is less than about 100, more typically less than about 50, and most typically less than about 25 ppb. It is to be appreciated that the upper limit and the lower limit of the dissolve copper can be selected independent from one another. The filtration system 70 removes the dissolved copper from the coolant composition 56 such that the average concentration of the dissolved copper in the coolant composition 56 is within the acceptable ranges listed above. Without the filtration system 70 of this invention, the average concentration of the dissolved copper in the coolant composition 56 would exceed 1000 ppb.

Generally, as the pH of the coolant composition increases, the copper oxide precipitates out of solution and can be filtered from the coolant composition 56. It is to be appreciated that the filtration system 70 can also remove copper oxide from the coolant composition 56. Additionally, when the manufacturing system 20 employs the deareation system, the deareated system may include the filtration system 70 for removing dissolved copper from the coolant composition 56.

In one embodiment, the filtration system 70 includes a filtration branch 72 in fluid communication with the main branch 62, the filtration system 70, and the main storage tank 60. The filtration branch 72 comprises a plurality of structural elements suitable for transporting the coolant composition 56 such as pipes, tubes, conduits and the like. The filtration branch 72 allows maintenance to be performed on the filtration system 70 without shutting down the manufacturing system 20. It is to be appreciated that the filtration system 70 can be in fluid communication with the main branch 62, thereby eliminating the filtration branch 72 from the circulation system 58.

A filtration branch valve diverts a portion of the coolant composition 56 from the main branch 62 into the filtration branch 72 for passing a portion of the coolant composition 56 through the filtration system 70. Typically, the coolant composition 56 passes through the filtration branch 72 at less than about 20, and more typically of from about 6 to 10 GPM. The filtration branch 72 allows for treating a lower flow rate as compared to the flow in the main branch 62 while still effectively controlling the dissolved copper content of the total volume of the coolant composition 56. Additionally, treating the coolant composition 56 at the lower flow rate reduces an operating cost of the filtration system 70 because the life of the filtration system 70 is extended as less of the coolant composition 56 is filtered per circulation cycle as compared to providing the filtration system 70 on the main branch 62. It is to be appreciated that the flow rate of the coolant composition 56 within the filtration system 70 depends upon the average concentration of dissolved copper present in the coolant composition 56, the total volume of the coolant composition 56 present in the circulation system 58, and the effectiveness of the filtration system 70 to remove the dissolved copper.

In one embodiment shown in FIG. 1, the filtration system 70 includes a cationic bed filter 74 containing a cationic resin for removing the dissolved copper from the coolant composition 56. It is to be appreciated that any type of cationic resin suitable for removing copper from the coolant composition 56 may be used. Typically, the cationic resin is sodium based, such as zeolite resin and styrene bead resin with a sodium hydroxide reactive group bonded to the surface. When the filtration system 70 is the cationic bed filter 74, an added benefit to maintaining a neutral or slightly basic pH of the coolant composition 56, as described above, is an increased life of the cationic resin in the cationic bed filter 74. Additionally, when the filtration system 70 is the cationic bed filter 74 it is advantageous to pass only a portion of the coolant composition 56 through the filtration branch 72 to conserve the life of the cationic resin.

The filtration system 70 may also includes at least one mixed bed filter 76 containing a mixed resin in fluid communication with the filtration branch 72. The mixed bed filter 76 removes the bicarbonate from the coolant composition 56 and, therefore, decreases the amount of basic substance that must be added to the coolant composition 56 to bring the pH within the acceptable rages set forth above. It is to be appreciated that any type of mixed resin know in the art may be used with the present invention. Typically, the mixed resin comprises a combination of cation and anion beads mixed together. Generally, the mixed bed filter 76 can also be used to remove minerals that might be suspended within the coolant composition 56. For example, when the coolant is tap water, the mixed bed filter 76 removes any minerals suspended in the tap water.

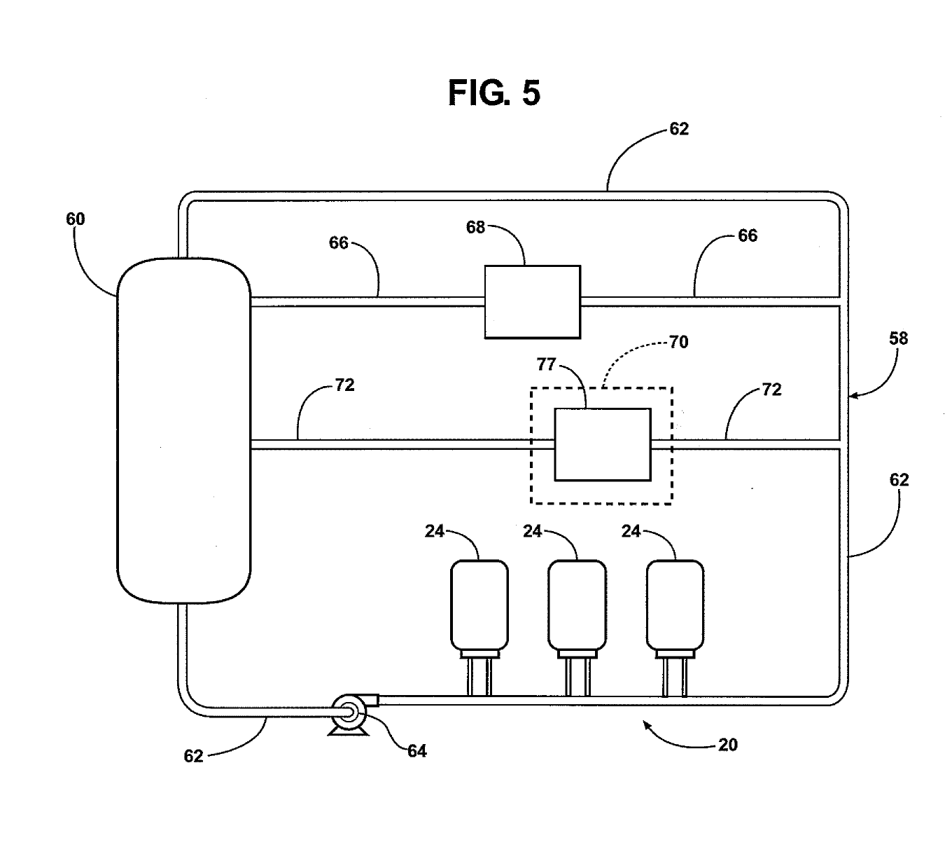

With reference to FIG. 5, the filtration system 70 includes a reverse osmosis processor 77 having a membrane configured to strain the dissolved copper from the coolant composition 56. It is to be appreciated that the reverse osmosis processor 77 may be used in conjunction with the cationic bed filter 74 or the reverse osmosis processor 77 may be used instead of the cationic bed filter 74.

The second layer of the three-layer control strategy typically maintains the pH of the coolant composition 56 of from about 7.0 to 9.5, and more preferably of from about 7.5 to 9.5 and most preferably of from about 7.5 to 9.5. In view of the pH ranges for the coolant composition, the amount of dissolved copper introduced into the coolant composition 56 over time is minimized. In view of the preferred pH ranges, the coolant composition 56 has an electrical conductivity preferably less than about 80, and more preferably of from about 10 to 80 micro-Seimens.

It is to be appreciated that the pH of the coolant composition 56 can be maintained by any method suitable for maintaining the pH of the coolant composition 56 known in the art. In one embodiment, a basic substance is added to the coolant composition 56 to counteract the effect of the bicarbonate on the pH of the coolant composition 56. It is to be appreciated that the basic substance may comprise any strong base, such as potassium hydroxide, sodium bicarbonate, and sodium hydroxide. It is also to be appreciated that a portion of the coolant composition 56 can be removed from the circulation system 58 and replaced with a fluid such that the replacement results in the pH of the coolant composition 56 being within the ranges described above. It is to be appreciated that the mixed bed filter 76 may be used in cooperation with the basic substance to control the pH of the coolant composition 56. In some instances, the mixed bed may be used in place of the addition of the basic substance altogether.

Referring still to FIG. 1, in one embodiment, a pH maintenance branch 66 is in fluid communication with the main branch 62 and the main storage tank 60. It is to be appreciated that maintaining the pH of the coolant composition 56 within the ranges described above can be completed within the main branch 62 eliminating the pH maintenance branch 66. When present, the pH maintenance branch 66 comprises a plurality of structural elements suitable for transporting the coolant composition 56 such as pipes, tubes, conduits and the like. A maintenance branch valve diverts a portion of the coolant composition 56 from the main branch 62 into the pH maintenance branch 66 for treating the coolant composition 56 to maintain the pH of the coolant composition 56. Typically, the coolant composition 56 passes through the pH maintenance branch 66 at less than about 20, and more typically of from about 6 to about 10 GPM. The pH maintenance branch 66 allows for treating a lower flow rate as compared to the flow in the main branch 62 while still effectively treating the total volume of the coolant composition 56.

It is to be appreciated that the pH maintenance branch 66 can be located either upstream or downstream of the reactor 24. A basic substance storage tank 68 is in fluid communication with the pH maintenance branch 66 for storing the basic substance. The basic substance from the basic substance storage tank 68 is added to the coolant composition 56 within the pH maintenance branch 66, to effectively control the pH of the total volume of the coolant composition 56. It is to be appreciated that the amount of caustic solution added to the coolant composition 56, as well as the rate of addition, is dependent upon the amount of bicarbonate present in the coolant composition 56 and the desired pH of the coolant composition 56.

The pH of the coolant composition 56 within the main storage tank 60 can be tested to ensure the pH of the coolant composition 56 is within the preferable range. The rate of addition of the basic substance can be adjusted based on the test results of the pH of the coolant composition 56 in the main storage tank 60. However, because the range of pH of the coolant composition 56 has an upper limit controlled by the electrical conductivity, controlling the pH of the coolant composition 56 alone does not completely prevent degradation of the cooling surface 38 or remove the dissolved copper from the coolant composition 56.

Referring to FIG. 4, the fluid connection between the main storage tank 60, the electrode 36, and the filtration system 70 is shown. It is to be appreciated that FIG. 4 is a schematic view and in no way represents sizes, configurations, actual concentrations, or distribution of the dissolved copper in the coolant composition 56. The concentration of dissolved copper within the coolant composition 56 increases as the coolant composition 56 contacts the cooling surface 38 due to degradation of the cooling surface 38. The highest concentration of dissolved copper within the coolant composition 56 occurs near the bottom end 44 of the electrode 36 as the coolant composition 56 leaves the channel 50 of the electrode 36. However, it is to be appreciated that dissolution of copper occurs over time and is a relatively slow process such that differences in dissolved copper concentration along the cooling surface 38 are negligible during normal flow of the coolant composition 56 through the circulation system 58. The filtration branch 72 is typically located downstream of the electrode 36 to filter the coolant composition 56 when the amount of dissolved copper is the highest. As described above, most of the coolant composition 56 continues through the main branch 62 back to the main storage tank 60 and a portion of the coolant composition is diverted into the filtration branch 72 and passed through the filtration system 70. After the coolant composition 56 passes through the filtration system 70, the concentration of dissolved copper is significantly reduced. Once the coolant composition 56 from the filtration system 70 is combined with the coolant composition 56 returned to the main storage tank 60 from the main branch 62, the concentration of dissolved copper is within the acceptable range as set forth above.

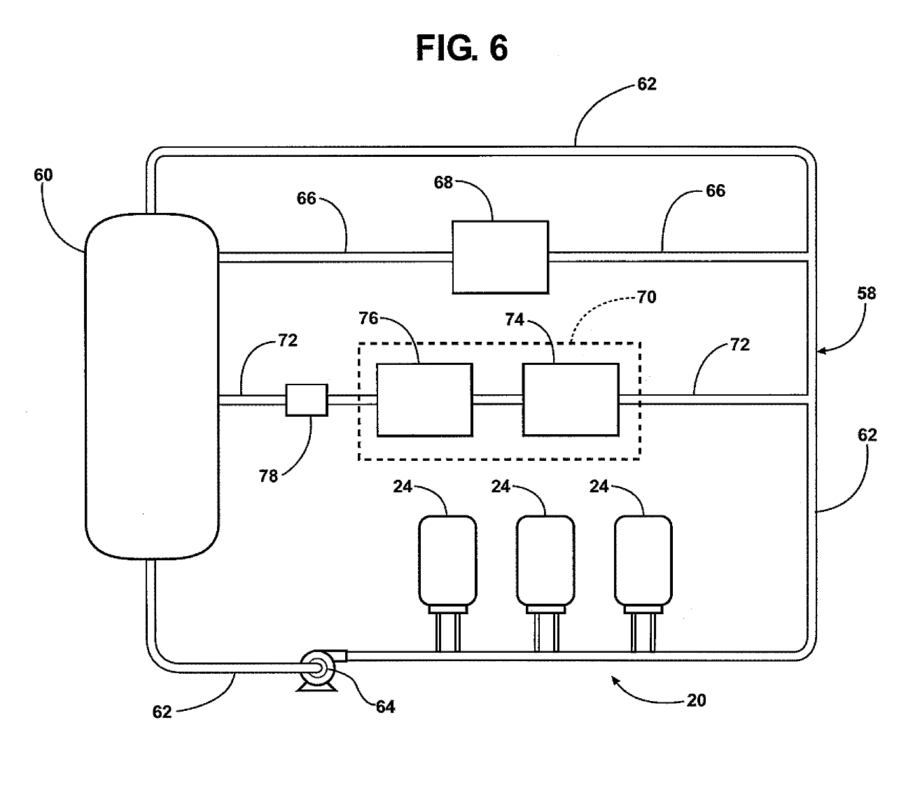

With reference to FIG. 6, the manufacturing system 20 may also include a degasifier 78 in fluid communication with the circulation system 58 for removing dissolved gases from the coolant composition 56. For example, the degasifier 78 removes the dissolved carbon dioxide and dissolved oxygen from the coolant composition 56. The removal of dissolved carbon dioxide from the coolant composition 56 reduces the formation of bicarbonate thereby maintaining the pH of the coolant composition 56. Additionally, the removal of dissolved oxygen from the coolant composition 56 inhibits the formation of deposits on the electrode 36 because there is less dissolved oxygen in the coolant composition 56 to react with the dissolved copper to form copper oxides. It is to be appreciated that the degasifier 78 may be any suitable degasifier including, but not limited to, forced draft degasifies, membrane contactors, and the like. An example of a suitable degasifier for use as the degasifier 78 is a LIQUI-CEL® Membrane Contactor. The degasifier 78 may be independent from the filtration system 70 or, the degasifier 78 may be incorporated into the filtration system 70. Although not required, the degasifier 78 is typically located downstream of the filtration system 70 to allow the dissolved copper to be removed from the coolant composition 56 prior to the coolant composition entering the degasifier 78.

It is to be appreciated that the dissolved oxygen present in the coolant composition 56 may be controlled by other suitable mechanisms and methods. For example, a sodium sulfite treatment may be used to chemically scavenge the dissolved oxygen. This scavenging may result in the formation of sulfate ions, which may be subsequently removed from the coolant composition 56.

It is also to be appreciated that the average concentration of the dissolved copper present in the coolant composition 56 may be controlled by other suitable methods. For example, corrosion inhibitors may be added to the coolant composition 56 for preventing degradation of the cooling surface 38. The corrosion inhibitors attach to the dissolved copper as a passivation layer and prevent the formation of copper oxide in the coolant composition 56. Additionally, a chelating agent may be added to the coolant composition 56 for reacting with the dissolved copper to prevent the formation of the copper-oxide,

A typical method of inhibiting formation of deposits on the cooling surface 38 of the electrode 36 used in the manufacturing system 20 for depositing the material on the carrier body 22 is described below. The method includes the steps of placing the carrier body 22 in contact with the electrode 36 within the chamber 26 and sealing the chamber 26. Subsequently, the step of heating the carrier body 22 and the electrode 36 is performed by passing the electric current generated by the power supply 54 through the electrode 36 and the carrier body 22. The method also includes the steps of introducing the precursor into the chamber 26 and depositing the material on the carrier body 22 once the carrier body 22 reaches the deposition temperature. In one embodiment, the step of depositing the material on the carrier body 22 is further defined as depositing silicon on the carrier body 22. Additionally, the step of depositing silicon on the carrier body 22 may result in the formation of polycrystalline silicon on the carrier body 22.

The method further includes the steps of contacting the cooling surface 38 of the electrode 36 with the coolant composition 56 to dissipate the heat within the electrode 36 and filtering the coolant composition 56 with the filtration system 70 to remove at least a portion of the dissolved copper therefrom. In one embodiment, the step of filtering the coolant composition 56 is further defined as passing the coolant composition through the filtration system 70 at less than about 20 GPM. The step of filtering the coolant composition 56 with the filtration system 70 removes the dissolved copper present in the coolant composition 56 entering the filtration system by the percentages indicated above.

In one embodiment, the filtration system 70 is the cationic bed filter 74 and the step of filtering the coolant composition 56 is further defined as passing as least a portion of the coolant composition through the cationic bed filter 74. In another embodiment, the filtration system 70 is the reverse osmosis processor 77 and the step of filtering the coolant composition 56 is further defined as passing as least a portion of the coolant composition through the reverse osmosis processor 77. The method may also include the step of removing at least a portion of the dissolved gasses from the coolant composition 56 using the degasifier 78.

The method may also include the steps of maintaining the pH of the coolant composition 56 and maintaining the electrical conductivity of the coolant composition 56 in the ranges listed above. It is to be appreciated that the step of maintaining the pH of the coolant composition 56 is further defined as adding a basic substance to the coolant composition 56. The processed carrier body 22 is then removed and a new carrier body 22 is placed in the manufacturing system 20.

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment may become apparent to those skilled in the art and do come within the scope of the invention.

1. A method of inhibiting formation of deposits on a cooling surface of an electrode used in a manufacturing system for depositing a material on a carrier body, where the cooling surface comprises copper, and where the manufacturing system includes at least one reactor defining a chamber with the electrode at least partially disposed within the chamber for supporting the carrier body within the chamber, a circulation system in fluid communication with the electrode for transporting a coolant composition to and from the cooling surface, with the coolant composition comprising a coolant and dissolved copper from the cooling surface of the electrode, and a filtration system in fluid communication with the circulation system, said method comprising the steps of:
heating the electrode supporting the carrier body;
contacting the cooling surface of the electrode with the coolant composition;
depositing the material on the carrier body supported by the electrode; and
filtering the coolant composition with the filtration system to filter at least a portion of the dissolved copper therefrom.

2. A method as set forth in claim 1 wherein the step of depositing the material on the carrier body is further defined as depositing silicon on the carrier body.

3. A method as set forth in claim 2 wherein the step of depositing silicon on the carrier body results in the formation of polycrystalline silicon on the carrier body.

4. A method as set forth in claim 1 wherein the step of filtering the coolant composition is further defined as passing the coolant composition through the filtration system at less than about 20 GPM.

5. A method as set forth in claim 1 wherein an average concentration of the dissolved copper present in the coolant composition is less than about 100 ppb.

6. A method as set forth in claim 1 wherein the filtration system is further defined as a cationic bed filter and the step of filtering the coolant composition is further defined as passing at least a portion of the coolant composition through the cationic bed filter.

7. A method as set forth in claim 1 wherein the filtration system is further defined as a reverse osmosis processor and the step of filtering the coolant composition is further defined as passing at least a portion of the coolant composition through the reverse osmosis processor.

8. A method as set forth in claim 1 further comprising the step of maintaining a pH of the coolant composition of from about 7.0 to 9.5.

9. A method as set forth in claim 1 further comprising the step of maintaining an electrical conductivity of the coolant composition to less about 80 micro-Seimens.

10. A method as set forth in claim 1 wherein the electrode further includes a head and a shaft each having a diameter with the diameter of the head being larger than the diameter of the shaft, and the cooling surface of the electrode defines a channel with the channel extending within the electrode a distance D that is less than a length L of the electrode, and the step of contacting the cooling surface of the electrode with the coolant composition is further defined as circulating the coolant composition within the channel.

11. A method as set forth in claim 1 wherein the coolant is deionized water.

12. A method set forth in claim 1 wherein the coolant composition further comprises dissolved gases and said method further comprises the step of removing at least a portion of the dissolved gasses from the coolant composition using a degasifier.

13. A method as set forth in claim 1 further comprising the step of adding a corrosion inhibitor to the coolant composition for preventing degradation of the cooling surface.

14. A method as set forth in claim 1 further comprising the step of adding a chelating agent to the coolant composition for reacting with the dissolved copper to prevent formation of copper-oxide in the coolant composition.

15-28. (canceled)

29. A manufacturing system for depositing a material on a carrier body, said system comprising:
at least one reactor defining a chamber;
at least one electrode at least partially disposed within said chamber for supporting the carrier body within said chamber, said electrode having a cooling surface comprising copper;
a circulation system coupled to said electrode for transporting a coolant composition into contact with said cooling surface, wherein the coolant composition comprises a coolant and dissolved copper with the coolant composition contacting said cooling surface of said electrode to dissipate heat generated in said electrode thereby preventing said electrode from reaching a deposition temperature where the material is deposited on the carrier body; and
a filtration system in fluid communication with said circulation system for removing at least a portion of the dissolved copper from the coolant composition.

30. A system as set forth in claim 29 wherein said filtration system comprises a cationic bed filter.

31. A system as set forth in claim 29 wherein said filtration system comprises a reverse osmosis processor.

32. A system as set forth in claim 29 wherein said electrode further includes a head and a shaft each having a diameter with said diameter of said head being larger than said diameter of said shaft and said cooling surface of the electrode defines a channel with the channel extending within said electrode a distance D that is less than a length L of said electrode.

33. A system as set forth in claim 32 wherein said copper of said cooling surface is further defined as oxygen-free electrolytic copper grade UNS 10100.

34. A system as set forth in claim 29 comprising a plurality of electrodes with said circulation system in fluid contact with said cooling surface of each of said electrodes for transporting the coolant composition to said cooling surface of each of said electrodes.

35. A system as set forth in claim 29 wherein the material deposited on the carrier body is silicon resulting in the formation of polycrystalline silicon on the carrier body.

36. A system as set forth in claim 29 further comprising a degasifier in fluid communication with said circulation system for removing at least a portion of dissolved gases from the coolant composition.

37-46. (canceled)
